(19) United States
(12) Patent Application Publication
(10) Pub. No.: US 2018/0331338 A1
(43) Pub. Date: Nov. 15, 2018

(54) BATTERY-MODULE HOUSING, METHOD FOR PRODUCING SUCH, AND BATTERY MODULE

(71) Applicant: Robert Bosch GmbH, Stuttgart (DE)

(72) Inventors: Michael Roderus, Stuttgart (DE); Stefan Baier, Ludwigsburg (DE)

(21) Appl. No.: 15/972,698

(22) Filed: May 7, 2018

(30) Foreign Application Priority Data
May 10, 2017 (DE) 102017207911.8

(51) Int. Cl. H01M 2/10; H01M 10/613; H01M 10/6551; H01M 10/6569

(52) U.S. Cl. CPC H01M 2/1077; H01M 10/6569; H01M 10/6551; H01M 10/613

(57) ABSTRACT

A battery-module housing having a first housing element and a second housing element, the first housing element being made from a metallic material, and having a base plate as well as a plurality of intermediate walls, which are connected to the base plate and which form a plurality of receiving chambers developed for the accommodation of battery cells, an intermediate wall being developed for a mechanical separation of two battery cells able to be accommodated in the battery-module housing, and the second housing element is made from a polymer material, the second housing element in particular being developed in the form of a trough or a tub, and the base plate of the first housing element and the second housing element jointly seal the plurality of receiving chambers from an environment.

### CROSS REFERENCE

The present application claims the benefit under 35 U.S.C. § 119 of German Patent Application No. DE 102017207911.8 filed on May 10, 2017, which is expressly incorporated herein by reference in its entirety.

### FIELD

The present invention relates to a battery-module housing. Furthermore, the present invention also relates to a method for producing such a battery-module housing. The subject matter of the present invention is also a battery module having such a battery-module housing.

### BACKGROUND INFORMATION

Battery-module housings made from aluminum or steel are available in the related art. Steel has high strength but also high density, which reduces the gravimetric energy density of a battery module. Aluminum, on the other hand, has a lower density and also exhibits excellent thermal conductivity.

However, in all battery-module housings, there arises the problem of insulating electrical contacts with respect to the battery-module housing.

In addition, the related art also includes the use of battery-module housings that are produced from plastic, which sometimes have insufficient mechanical strength, however, and are also limited in their thermal conductivity.

German Patent Application No. DE 10 2015 111 326 A1 describes a part of a battery-module housing for a traction battery.

German Patent Application No. DE 10 2015 206 182 A1 describes a cell module which includes a cell-module housing provided with an electrical insulation.

German Patent Application No. DE 10 2013 112 413 A1 describes a battery-housing part for a traction battery.

Furthermore, German Patent Application No. DE 10 2015 010 925 A1 describes a battery module having a temperature unit.

### SUMMARY

An example battery-module housing in accordance with the present invention may offer the advantage that a battery-module housing having a relatively low weight is able to be developed, which simultaneously is capable of reliably dissipating heat that is generated by battery cells accommodated in the battery-module housing.

According to the present invention, a battery-module housing, which has a first housing element and a second housing element, is made available for this purpose. The first housing element is produced from a metallic material.

In addition, the first housing element has a base plate and a plurality of intermediate walls, which are connected to the base plate. The plurality of intermediate walls creates a plurality of receiving chambers, which are developed to accommodate battery cells. In this context, an intermediate wall is designed to mechanically separate two battery cells capable of being accommodated in the battery-module housing. The second housing element is developed from a polymer material. More specifically, the second housing element is developed in the shape of a trough or a tub.

The base plate of the first housing element and the second housing element jointly seal the plurality of receiving chambers from an environment.

The measures described herein allow for advantageous further developments of and improvements in the devices in accordance with the present invention.

The joint sealing of the plurality of receiving chambers by the base plate of the first housing element and the second housing element is to be understood in such a way that especially only the base plate of the first housing element and the second housing element are accessible from an environment of the battery-module housing. In other words, only the base plate of the first housing element and the second housing element form the external delimitation of the battery-module housing.

The intermediate walls of the first housing element form receiving chambers that are designed for the accommodation of battery cells, which particularly means that the intermediate walls are disposed in direct contact with the battery cells or are disposed directly adjacent to the battery cells. This allows for a reliable heat transfer between the intermediate walls and the battery cells.

It is useful if the metallic material from which the first housing element is developed is selected from the group of aluminum, copper, nickel, steel or iron.

This allows for the reliable dissipation of heat from the battery module. In addition, a development made of aluminum is especially advantageous inasmuch as aluminum has a relatively low density, which therefore makes it possible to develop a battery-module housing that has a low weight, which in turn allows the gravimetric energy density to be increased.

It is also useful if the polymer material from which the second housing element is produced is selected from the group of elastomer, thermoplastic or thermoset plastic. Due to the low density of such materials, a battery-module housing is able to be developed that has a lighter weight.

In an advantageous manner, the polymer material also includes at least one reinforcement fiber. Any conventional reinforcement fiber may be used for this purpose. The at least one reinforcement fiber may be glass fiber, in particular. Glass fibers offer the advantage of being electrically insulating, and voltage taps conducted out of the battery module, for instance, are able to be reliably insulated.

In addition, introducing at least one reinforcement fiber into the polymer material of the second housing element may increase the mechanical strength of the battery-module housing. Reinforcement fibers do not increase the density of the second housing element or do not increase it to such an extent that a development of a battery-module housing at a relatively low weight would be possible.

According to one advantageous aspect of the present invention, the first housing element is developed as one piece and/or the second housing element is developed as one piece. This allows for a simple development of the battery-module housing.

It is advantageous if the second housing element includes at least one opening, which is developed so that a voltage tap of a battery cell is able to be passed through. Since the polymer material of the second housing element may be developed to be electrically insulating, it is possible to dispense with additional insulation measures when passing a voltage tap of a battery cell through from an interior of the battery-module housing, in particular from one of the receiving chambers.

According to one advantageous aspect of the present invention, the first housing element includes at least one flow channel, which is developed for the throughflow of temperature-conditioning fluid, a phase-change material, or at least one cooling fin.

Since the metallic material of the first housing element, in particular aluminum, exhibits a relatively satisfactory heat conductivity, heat generated by the battery cells is able to be conducted, in particular by way of the plurality of intermediate walls, to the base plate of the first housing element, which is accessible from the direction of an environment of the battery-module housing.

It is therefore possible to reliably dissipate heat generated by the battery cells by way of the base plate of the first housing element, the heat evacuation advantageously being facilitated by a development of the base plate of the first housing element that includes a flow channel developed so that temperature-conditioning fluid is able to flow through, a phase-change material, or at least one cooling fin.

Apart from subdividing the battery module into individual receiving chambers for the battery cells, the first housing element therefore also ensures a reliable temperature control.

It should also be noted at this point that the first housing element, for example, is also capable of ensuring heating of the battery cells because heat conveyed to the base plate may be conducted to the battery cells with the aid of the intermediate walls in order to maintain a required operating temperature of the battery cells or in order to warm the battery cells to the operating temperature, for example.

According to one useful aspect of the present invention, the plurality of receiving chambers has six boundary surfaces in each case. The first housing element forms three of the six boundary surfaces, and the second housing element forms three of the six boundary surfaces.

More specifically, the base plate of the first housing element forms one of the six boundary surfaces, and a first intermediate wall forms one of the six boundary surfaces while a second intermediate wall forms one of the six boundary surfaces.

This particularly also means that the plurality of receiving chambers formed by the first housing element is preferably open on three sides, so that an advantageous and simple production of the first housing element, e.g., in the form of an extrusion profile, is possible.

In particular, the second housing element has a further base plate, which is situated opposite from the base plate of the first housing element.

Moreover, the second housing element particularly includes a plurality of further housing walls, which are connected to the further base plate. The base plate of the first housing element and the further base plate of the second housing element as well as the further housing walls of the second housing element seal the plurality of receiving chambers from the environment. The second housing element may be developed in the form of a trough or a tub, for example.

According to one advantageous aspect of the present invention, the first housing element and the second housing element are connected to each other. The created connection is developed in a circumferentially sealing manner. More specifically, the first housing element and the second housing element are connected in an integral or form-locked fashion.

For example, a circumferential flange connection may be provided in order to create a circumferentially sealed, form-locked connection between the first housing element and the second housing element. To develop a circumferentially sealed, integral connection between the first housing element and the second housing element, it is possible to bond or thermally join the first housing element and the second housing element to each other, for instance. Virtually any material components are capable of being integrally joined to one another in a bonding process.

When selecting a thermoplastic as the polymer material of the second housing element, for example, the first housing element and the second housing element may be joined to each other via thermal joining, for which the material of the second housing element is melted in the region of the joining zone and press-fit with the first housing element in the joining zone.

In addition, the present invention also relates to a method for producing a battery-module housing. In this case, a first housing element of a metallic material is developed in a first method step in such a way that the first housing element includes a base plate and a plurality of intermediate walls that are connected to the base plate. The plurality of intermediate walls forms a plurality of receiving chambers developed for the accommodation of battery cells. An intermediate wall is designed to mechanically separate two battery cells that are able to be accommodated in the battery-housing module.

In a second method step, a second housing element is developed from a polymer material. More specifically, the second housing element is developed in the form of a trough or a tub.

In a third method step, the plurality of receiving chambers is jointly sealed from an environment by the base plate of the first housing element and the second housing element.

It should be noted at this point that the method according to the present invention may of course also encompass all other further refinements described in connection with the battery-module housing according to the present invention.

More specifically, it is useful if the first housing element is developed with the aid of an extrusion, flow-pressing or extrusion-molding method or a casting method. The first housing element is developed as an aluminum extrusion part or as a cast aluminum part, in particular.

It should be noted in this context that it is possible, for one, to develop the first housing element in the first method step as one piece, or for another, to form multiple sections of the first housing element using extrusion, flow-pressing and extrusion-molding methods or a casting method, the sections being connected to one another in order to form the first housing element using a welding or plug-in connection, for example.

It is advantageous, in particular, if the second housing element is developed with the aid of a thermoforming method or a resin-transfer molding method. The second housing element may be developed as one piece, in particular. In an advantageous manner, a second housing element, especially one developed from a thermoplastic, is produced with the aid of a thermoforming method. A second housing element, especially one developed from a thermoset plastic, is advantageously produced using a resin-transfer molding method.

A battery-module housing according to the present invention or a battery-module housing produced using the method according to the present invention specifically offers the advantage of allowing the particular demands of battery cells capable of being accommodated in the battery-module housing to be taken into account through the choice of the metallic material for the first housing element and/or through the choice of the polymer material for the second housing element. For example, different operating temperatures or different media loads may be considered by the choice of the polymer material.

In particular when the battery-module housing is developed according to the present invention, it is advantageously possible to combine the excellent thermal conductivity of the metallic material and the low density as well as the electrical insulating effect of the polymer material with each other. A battery-module housing having a relatively low weight may be developed especially when aluminum is selected as the metallic material inasmuch as both aluminum and the polymer material have a relatively low density.

In addition, the present invention also relates to a battery module having a battery-module housing according to the present invention, or to a battery-module housing produced using the method according to the present invention. Battery cells are accommodated in the plurality of receiving chambers.

Such a battery module may be used in electric vehicles, plug-in hybrid vehicles, mobile electronic devices, or also in stationary accumulators, for instance.

### BRIEF DESCRIPTION OF THE DRAWINGS

Specific embodiments of the present invention are shown in the figures and described in greater detail below.

FIG. 1 shows, perspectively, an illustration of a first housing element of a battery-module housing according to the present invention.

FIG. 2 shows, perspectively, an illustration of a second housing element of a battery-module housing according to the present invention, in a full view and a longitudinal section.

FIG. 3 shows, perspectively, an illustration of a battery-module housing according to the present invention in a longitudinal section.

FIG. 4 shows, perspectively, an illustration of a battery module according to the present invention.

### DETAILED DESCRIPTION OF EXAMPLE EMBODIMENTS

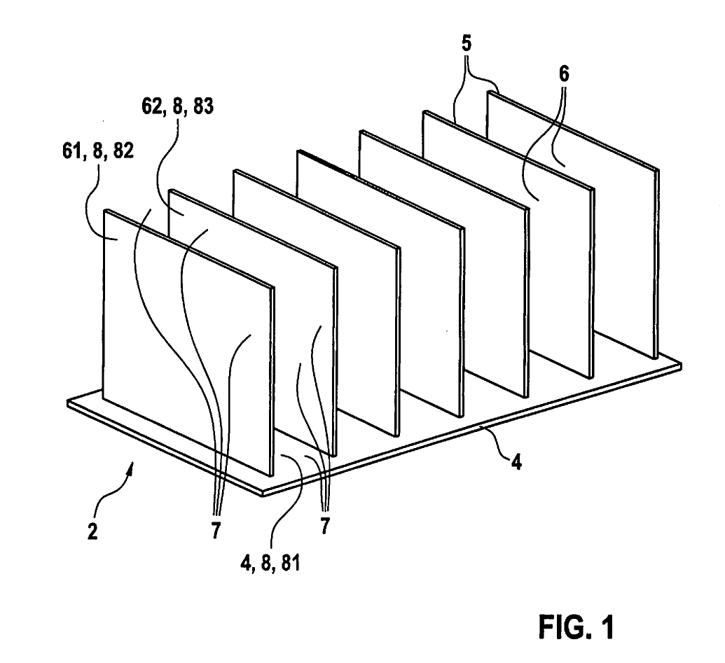

FIG. 1 perspectively show an illustration of a first housing element 2 of a battery-module housing 1 according to the present invention.

First housing element 2 is made from a metallic material. First housing element 2 according to FIG. 1 is produced from aluminum, but a development using copper, nickel, steel or iron is also an option.

First housing element 2 has a base plate 4 and a plurality of intermediate walls 5. As can be gathered from FIG. 1, each intermediate wall 5 is connected to base plate 4. More specifically, intermediate walls 5 are disposed at a right angle to base plate 4.

Intermediate walls 5 form a plurality of receiving chambers 6, which are designed to accommodate battery cells. According to FIG. 1, one battery cell is able to be accommodated between two intermediate walls 5 in each case, but it is of course also possible to place a plurality of battery cells between two intermediate walls 5.

An intermediate wall 5 is furthermore developed for the mechanical separation of two battery cells which are capable of being accommodated in battery-module housing 1.

According to FIG. 1, first housing element 2 is developed as one piece.

As can be gathered from FIG. 1, a receiving chamber 6 has six boundary surfaces 7 in each case. First housing element 2 forms three boundary surfaces 8 of the six boundary surfaces 7. More specifically, base plate 4 forms a first boundary surface 81 of the three boundary surfaces 8. A first intermediate wall 61 in particular forms a second boundary surface 82 of the three boundary surfaces 8. A second intermediate wall 62, in particular, forms a third boundary surface 83 of the three boundary surfaces 8.

It should be noted in this context that base plate 4 of first housing element 2 may include a flow channel, developed for a temperature conditioning fluid to flow through, a phase-change material, or a cooling fin, this not being shown in FIG. 1, however.

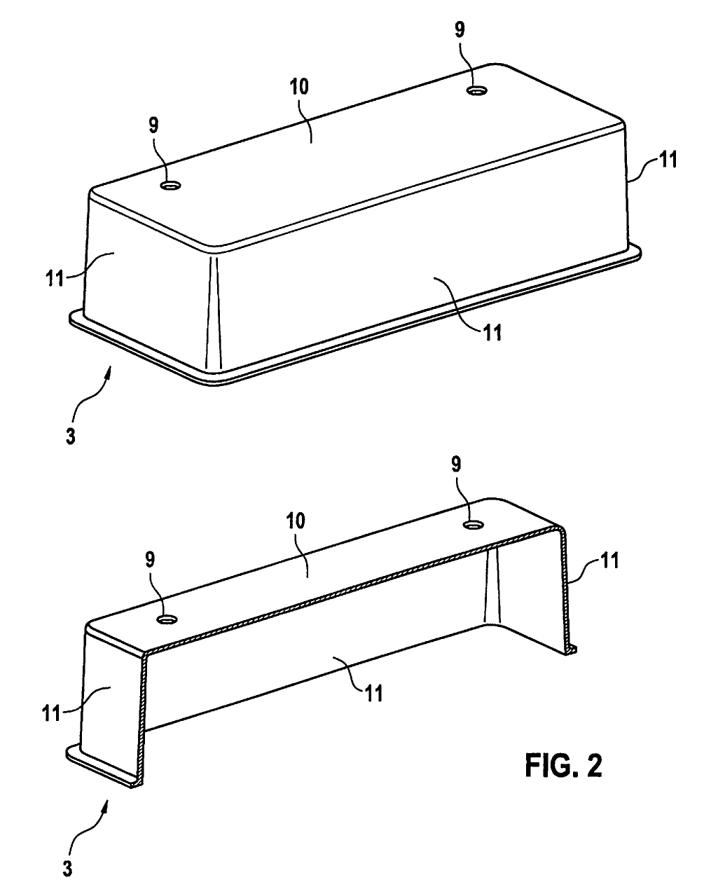

FIG. 2 shows in a perspective view a second housing element 3, in a full view on the one hand, and in a sectional view on the other hand.

Second housing element 3 is developed from a polymer material; for example, second housing element 3 may be developed from an elastomer, a thermoplastic, or a thermoset plastic.

In addition, the polymer material may also include at least one reinforcement fiber.

It may also be gathered from FIG. 2 that second housing element 3 is developed as one piece. In particular, second housing element 3 according to FIG. 2 is developed in the form of a trough or a tub.

Second housing element 3 is provided with openings 9, which are developed so that voltage taps of battery cells accommodated in battery-module housing 1 are able to be passed through. In this instance, it is advantageously possible to dispense with an electrical insulation of second housing element 3 with regard to the voltage taps because the polymer material is preferably electrically insulating.

Second housing element 3 includes a further base plate 10, which is situated opposite from base plate 4 of first housing element 2 when battery-module housing 1 is in the assembled state. In addition, second housing element 3 has a plurality of further housing walls 11, which are connected to further base plate 10. In particular, further housing walls 11 may be disposed at a right angle to further base plate 10, or further housing walls 11 may also be situated at an angle that deviates by no more than 15 degrees from an orthogonal placement.

In an assembled state of battery-module housing 1, base plate 4 of first housing element 2 and further base plate 10 as well as further housing walls 11 jointly seal the plurality of receiving chambers 6 from an environment 12.

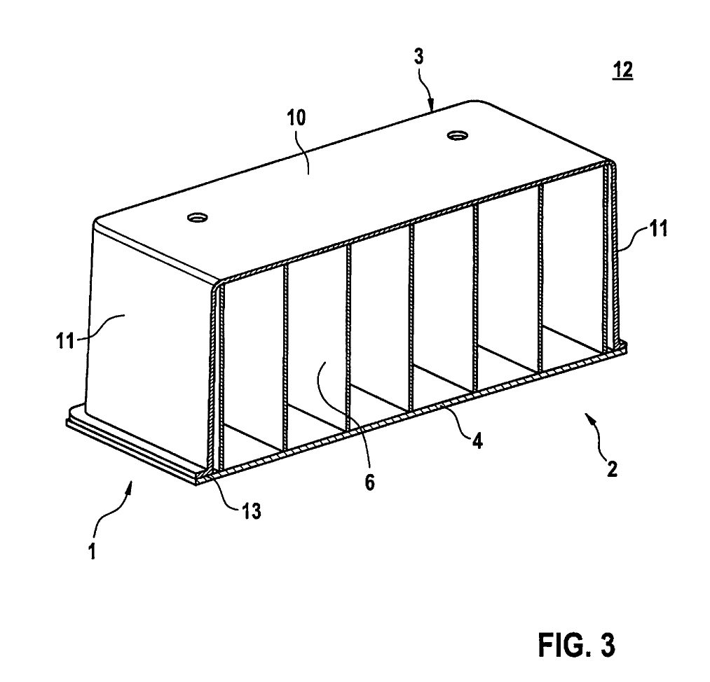

FIG. 3 shows an illustration of a battery-module housing 1 according to the present invention in a sectional, perspective view.

FIG. 3 illustrates that base plate 4 of first housing element 2 and second housing element 3 jointly seal the plurality of receiving chambers 6 from an environment of battery-module housing 1.

More specifically, it may be gathered from FIG. 3 that further base plate 10 of second housing element 3 is situated opposite from base plate 4 of first housing wall 2. In addition, it may particularly also be gathered from FIG. 3 that base plate 4 of first housing element 2 and further base plate 10 of second housing element 3 as well as further housing walls 11 of second housing element 3 seal the plurality of receiving chambers 6 from an environment 12 of battery module 1.

First housing element 2 and second housing element 3 are connected to each other. The produced connection, which is to be denoted by reference numeral 13 in FIG. 3, is developed so as to be circumferentially sealing.

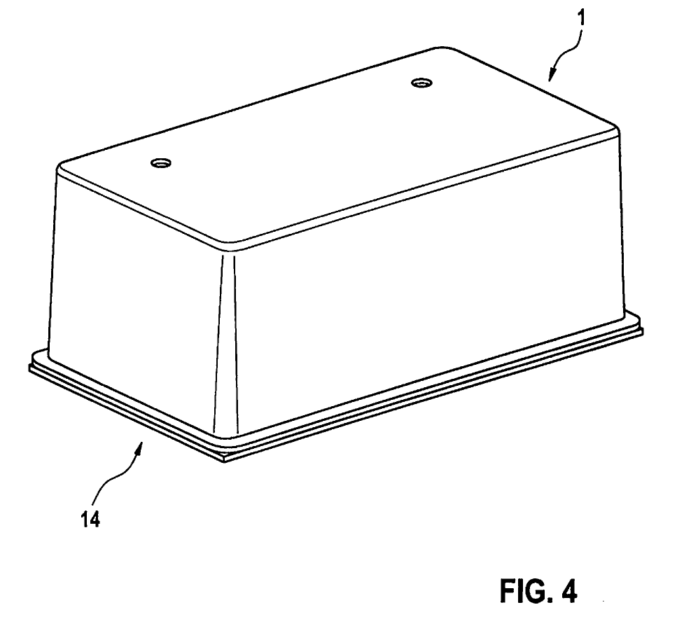

In a perspective view, FIG. 4 shows a battery module 14 according to the present invention, which has a battery-module housing 1 according to the present invention. Battery cells, which are not visible in FIG. 4, are accommodated inside receiving chambers 6.

What is claimed is:

1. A battery-module housing, comprising:
a first housing element made from a metallic material and having a base plate and a plurality of intermediate walls, which are connected to the base plate and form a plurality of receiving chambers to accommodate battery cells, each of the intermediate walls to mechanically separate two of the battery cells;
a second housing element made from a polymer material and being in the shape of one of a trough or a tub;
wherein the base plate of the first housing element and the second housing element jointly seal the plurality of receiving chambers from an environment.

2. The battery-module housing as recited in claim 1, wherein the metallic material is selected from the group of aluminum, copper, nickel, steel or iron.

3. The battery-module housing as recited in claim 1, wherein the polymer material is selected from the group of elastomeric, thermoplastic or thermoset plastic.

4. The battery-module housing as recited in claim 3, wherein the polymer material includes at least one reinforcement fiber, the at least one reinforcement fiber being glass fiber.

5. The battery-module housing as recited in claim 1, wherein at least one of: (i) the first housing element is developed as one piece, and (ii) the second housing element is developed as one piece.

6. The battery-module housing as recited in claim 1, wherein the second housing element has at least one opening developed for passing through a voltage tap of a battery cell.

7. The battery-module housing as recited in claim 1, wherein the first housing element includes one of: (i) at least one flow channel for a throughflow of a temperature-control fluid, (ii) a phase-change material, or (iii) at least one cooling fin.

8. The battery-module housing as recited in claim 1, wherein each of the plurality of receiving chambers has six boundary surfaces, and the first housing element forms three boundary surfaces of the six boundary surfaces.

9. The battery-module housing as recited in claim 1, wherein the second housing element includes a further base plate, which is disposed opposite from the base plate of the first housing element, and the second housing element includes a plurality of further housing walls, which are connected to the further base plate, the base plate of the first housing element, the further base plate, and the further housing walls jointly sealing the plurality of receiving chambers from the environment.

10. The battery-module housing as recited in claim 1, wherein the first housing element and the second housing element are connected to each other, and the connection is developed to be circumferentially sealing, the first housing element and the second housing element being one of: (i) joined in an integral fashion, or (ii) connected to each other in a form-locked fashion.

11. The battery-module housing as recited in claim 10, wherein the first housing element a joint together via one of bonding or thermal joining.

12. A method for producing a battery-module housing, the method comprising:
developing a first housing element from a metallic material, the first housing element having a base plate and a plurality of intermediate walls connected to the base plate to form a plurality of receiving chambers to accommodate battery cells, and each of the intermediate walls designed to mechanically separate two of the battery cells;
developing a second housing element from a polymer material, the second housing element being developed in the form of one of a trough or a tub; and
jointly sealing the plurality of receiving chambers from an environment by the base plate of the first housing element and the second housing element.

13. The method as recited in the claim 12, wherein the first housing element is developed using one of: (i) an extrusion method, (ii) a flow-pressing method, (iii) an extrusion-molding method, or (iv) a casting method.

14. The method as recited in claim 12, wherein the second housing element is developed using one of a thermoforming method or a resin transfer-molding method.

15. A battery module, comprising:
a plurality of battery cells; and
a battery-module housing including a first housing element made from a metallic material and having a base plate and a plurality of intermediate walls, which are connected to the base plate and form a plurality of receiving chambers accommodating the battery cells, each of the intermediate walls mechanically separating two of the battery cells, and a second housing element made from a polymer material and being in the shape of one of a trough or a tub, wherein the base plate of the first housing element and the second housing element jointly seal the plurality of receiving chambers from an environment.
